(19) United States
(12) Patent Application Publication
(10) Pub. No.: US 2018/0029221 A1
(43) Pub. Date: Feb. 1, 2018

(54) ROBOT AND ROBOT SYSTEM

(71) Applicant: Seiko Epson Corporation, Tokyo (JP)

(72) Inventors: Toshio TANAKA, Azumino (JP); Izumi IIDA, Shiojiri (JP); Masaru TAKAHASHI, Matsumoto (JP)

(21) Appl. No.: 15/660,188

(22) Filed: Jul. 26, 2017

(30) Foreign Application Priority Data
Jul. 29, 2016 (JP) 2016-149423

(51) Int. Cl. B25J 9/00; B25J 15/02; B25J 18/00; B25J 15/04

(52) U.S. Cl. CPC B25J 9/0009; B25J 15/0433; B25J 15/0253; B25J 18/007; B25J 9/0081

(57) ABSTRACT

A robot includes a manipulator, in which a handle for moving the manipulator can be attached and detached in a plurality of positions of the manipulator.

### BACKGROUND

### 1. Technical Field

The present invention relates to a robot and a robot system.

### 2. Related Art

Research and development of methods of teaching actions of robots to robot control apparatuses for operating robots by users operating robots with hands (direct teaching) are carried out.

In this regard, a direct teach rod adapted to be attachable to a wrist of a robot and having a plurality of deadman switches connected to individually enable emergency stop of the robot and operation units thereof provided around the rod in different directions with a center on a rod axis is known (see Patent Document 1 (JP-A-06-8168)).

However, in the direct teach rod, when an action of the robot is taught to the robot control apparatus by direct teaching, it may be difficult to move the robot because the direct teach rod interferes with a surrounding environment depending on the attitude of the robot. The surrounding environment refers to e.g. a part of the robot, an object existing around the robot, or the like.

### SUMMARY

An aspect of the invention is directed to a robot including a manipulator, wherein a handle for moving the manipulator can be attached and detached in a plurality of positions of the manipulator.

According to the configuration, in the robot, the handle for moving the manipulator can be attached and detached in the plurality of positions of the manipulator. Thereby, the robot may enable the user to move the manipulator using the handle attached to a desired position of the plurality of positions of the manipulator.

In another aspect of the invention, the robot may be configured such that the handle includes a wiring cable, and the wiring cable is connectable using a first connector provided in the manipulator of the robot.

According to this configuration, in the robot, the wiring cable of the handle is connectable using the first connector provided in the manipulator of the robot. Thereby, the robot may enable the user to move the manipulator using the handle with the short wiring cable.

In another aspect of the invention, the robot may be configured such that the wiring cable is connectable using a second connector provided in the manipulator of the robot.

According to this configuration, in the robot, the wiring cable of the handle is connectable using the second connector provided in the manipulator of the robot. Thereby, the robot may enable the user to move the manipulator using the handle with the wiring cable connected to a desired connector.

In another aspect of the invention, the robot may be configured such that the manipulator includes a first arm, and the first arm includes a first attachment and detachment part to and from which the handle can be attached and detached, and a second attachment and detachment part different from the first attachment and detachment part to and from which the handle can be attached and detached.

According to this configuration, in the robot, the first arm includes the first attachment and detachment part to and from which the handle can be attached and detached, and the second attachment and detachment part different from the first attachment and detachment part to and from which the handle can be attached and detached. Thereby, the robot may enable the user to move the manipulator using the handle attached to a desired attachment and detachment part.

In another aspect of the invention, the robot may be configured such that the first arm is located on a distal end of a plurality of arms of the manipulator.

According to this configuration, in the robot, the first arm is located on the distal end of the plurality of arms of the manipulator. Thereby, the robot may enable the user to move the manipulator using the handle attached to the first arm located on the distal end of the plurality of arms of the manipulator.

In another aspect of the invention, the robot may be configured such that the handle has a grip part extending in a direction crossing a rotation axis of the first arm.

According to this configuration, in the robot, the handle has the grip part extending in the direction crossing the rotation axis of the first arm. Thereby, the robot may enable the user to move the manipulator using the handle having the grip part extending in the direction crossing the rotation axis of the first arm.

In another aspect of the invention, the robot may be configured such that the handle is provided in a first attitude or a second attitude in the first attachment and detachment part.

According to this configuration, in the robot, the handle is provided in the first attitude or the second attitude in the first attachment and detachment part. Thereby, the robot may enable the user to move the manipulator using the handle attached to the first attachment and detachment part in a desired attitude.

In another aspect of the invention, the robot may be configured such that a force detection unit is provided in the manipulator.

According to this configuration, the robot includes the force detection unit provided in the manipulator. Thereby, the robot may enable the user to move the manipulator by applying a force to the force detection unit using the handle.

In another aspect of the invention, the robot may be configured such that a force detection unit is provided in the manipulator, and has an attachment and detachment part to and from which the handle can be attached and detached provided closer to the distal end than the force detection unit.

According to this configuration, the robot includes the attachment and detachment part to and from which the handle can be attached and detached closer to the distal end than the force detection unit. Thereby, the robot may enable the user to move the manipulator by applying a force to the force detection unit using the handle attached closer to the distal end than the force detection unit.

In another aspect of the invention, the robot may be configured such that the manipulator includes a second arm, and the second arm has a third attachment and detachment part to and from which handle can be attached and detached.

According to this configuration, in the robot, the second arm has the third attachment and detachment part to and from which the handle can be attached and detached. Thereby, the robot may enable the user to move the manipulator using the handle attached to the third attachment and detachment part of the second arm.

In another aspect of the invention, the robot may be configured such that the manipulator has seven or more arms.

According to this configuration, in the robot, the manipulator has the seven or more arms. Thereby, the robot may enable the user to move the manipulator using the handle attached to a desired position of the plurality of positions of the manipulator having the seven or more arms.

In another aspect of the invention, the robot may be configured such that the handle includes a redundant axis operation part for operating the arm having a redundant axis of the manipulator of the seven or more arms.

According to this configuration, in the robot, the handle includes the redundant axis operation part for operating the arm having the redundant axis of the manipulator of the seven or more arms. Thereby, the robot may enable the user to rotate the redundant axis to a desired rotation angle using the redundant axis operation part.

In another aspect of the invention, the robot may be configured such that the handle is provided with an enable switch that enables movement of the manipulator.

According to this configuration, in the robot, the handle is provided with the enable switch that enables movement of the manipulator. Thereby, the movement of the manipulator is enabled by the enable switch, and the robot may enable the user to move the manipulator using the handle.

In another aspect of the invention, the robot may be configured such that the enable switch can be located in a first position, a second position, and a third position, and, when the enable switch is located in the second position, the movement of the manipulator is enabled and the second position is located between the first position and the third position.

According to this configuration, in the robot, the enable switch can be located in the first position, the second position, and the third position. When the enable switch is located in the second position, the movement of the manipulator is enabled and the second position is located between the first position and the third position. Thereby, the movement of the manipulator is enabled by the enable switch located in the second position, and the robot may enable the user to move the manipulator using the handle.

In another aspect of the invention, the robot may be configured such that the handle can allow a robot control apparatus to store at least one of a position and an attitude of the manipulator.

According to this configuration, in the robot, the handle can allow the robot control apparatus to store at least one of the position and the attitude of the manipulator. Thereby, the robot may perform a work based on at least one of the position and the attitude of the manipulator stored in the robot control apparatus by the handle.

In another aspect of the invention, the robot may be configured such that, as the manipulators, a first manipulator and a second manipulator different from the first manipulator are provided.

According to this configuration, in the robot, as the manipulators, the first manipulator and the second manipulator different from the first manipulator are provided. Thereby, the robot may enable the user to move the first manipulator using the handle attached to a desired position of a plurality of positions of the first manipulator, and enable the user to move the second manipulator using the handle attached to a desired position of a plurality of positions of the second manipulator.

Another aspect of the invention is directed to a robot system including the handle, the robot described above, and a robot control apparatus that controls the robot.

According to this configuration, in the robot system, the handle for moving the manipulator can be attached and detached in a plurality of positions of the manipulator. Thereby, the robot system may enable the user to move the manipulator using the handle attached to a desired position of the plurality of positions of the manipulator.

As descried above, in the robot and the robot system, the handle for moving the manipulator can be attached and detached in the plurality of positions of the manipulator. Thereby, the robot and the robot system may enable the user to move the manipulator using the handle attached to a desired position of the plurality of positions of the manipulator.

### BRIEF DESCRIPTION OF THE DRAWINGS

The invention will be described with reference to the accompanying drawings, wherein like numbers reference like elements.

FIG. 1 shows an example of a configuration of a robot system 1 according to an embodiment.

FIG. 2 is a perspective view of an example of an operation unit 50.

FIG. 3 is a perspective view when the operation unit 50 shown in FIG. 2 is seen from another angle.

FIG. 4 is a side view of the operation unit 50 when the operation unit 50 shown in FIG. 2 is seen from a positive direction toward a negative direction of an X-axis in a three-dimensional local coordinate system HC.

FIG. 5 is a perspective view of an example of a flange F to which an end effector E is attached.

FIG. 6 shows an example of a state in which the operation unit 50 is attached to an attachment and detachment part MT1 shown in FIG. 5.

FIG. 7 shows an example of a state in which the operation unit 50 is attached to the attachment and detachment part MT1 in an attitude different from an attitude of the operation unit 50 shown in FIG. 6.

FIG. 8 shows an example of a configuration of a robot system 2 according to a modified example of the embodiment.

### DESCRIPTION OF EXEMPLARY EMBODIMENTS

### Embodiment

As below, an embodiment of the invention will be explained with reference to the drawings.

### Configuration of Robot System

First, a configuration of a robot system 1 will be explained.

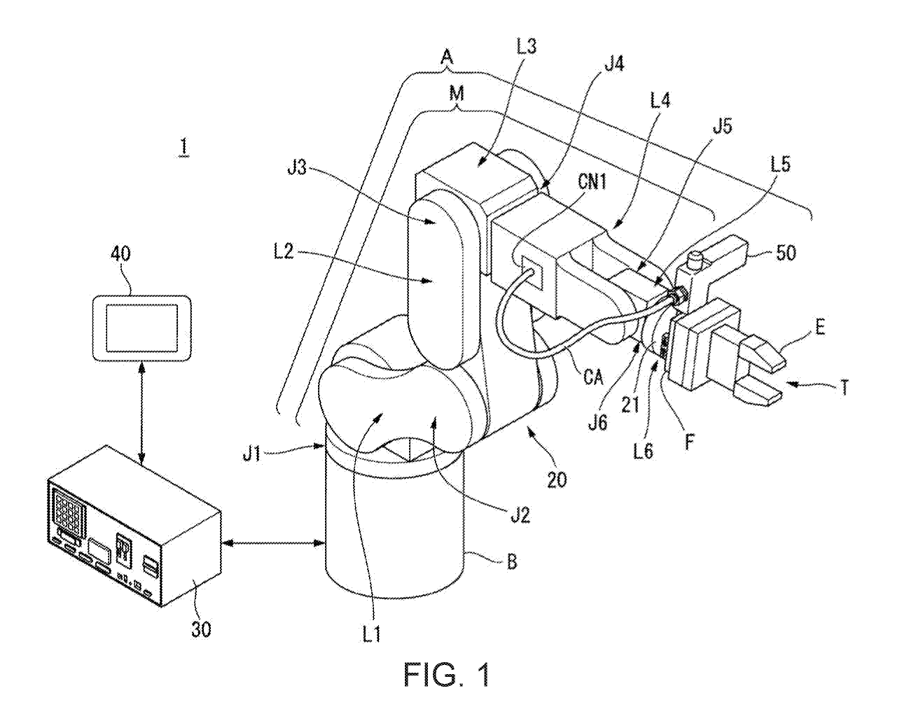

FIG. 1 shows an example of a configuration of the robot system 1 according to the embodiment. The robot system 1 includes a robot 20, a robot control apparatus 30, a teaching apparatus 40, and an operation unit 50.

The robot 20 is a single-arm robot including a movable unit A and a support B that supports the movable unit A. The single-arm robot is a robot having a single movable unit (arm) like the movable unit A in the example. Note that the robot 20 may be a multi-arm robot in place of the single-arm robot. The multi-arm robot is a robot having two or more movable units (e.g. two or more movable units A). Of the multi-arm robots, a robot having two movable units is also called a dual-arm robot. That is, the robot 20 may be a dual-arm robot having two movable units or a multi-arm robot having three or more movable units (e.g. three or more movable units A). Or, the robot 20 may be another robot such as a scalar robot, Cartesian coordinate robot, or cylindrical robot. The Cartesian coordinate robot is e.g. a gantry robot.

The movable unit A includes an end effector E and a manipulator M.

The end effector E is an end effector having a finger part that can grasp an object in the example. Note that the end effector E may be another end effector that can lift an object using suction by air, a magnetic force, a jig, or the like in place of the end effector having the finger part.

The end effector E is communicably connected to the robot control apparatus 30 by a cable. Thereby, the end effector E performs actions according to control signals acquired from the robot control apparatus 30. Wired communications via the cable are performed according to standards of e.g. Ethernet (registered trademark), USB (Universal Serial Bus), or the like. Or, the end effector E may be adapted to be connected to the robot control apparatus via wireless communications performed according to communication standards of Wi-Fi (registered trademark) or the like.

The manipulator M has joints J1 to J6 as six joints, arms L1 to L6 as six arms (link members), and a force detection unit 21. The support B and the arm L1 are coupled by the joint J1. The arm L1 and the arm L2 are coupled by the joint J2. The arm L2 and the arm L3 are coupled by the joint J3. The arm L3 and the arm L4 are coupled by the joint J4. The arm L4 and the arm L5 are coupled by the joint J5. The arm L5 and the arm L6 are coupled by the joint J6. That is, the arm L6 is an arm located on the distal end of the six arms of the manipulator M. The distal end refers to an opposite end to the support B of the ends of the manipulator M. Further, the arm L6 includes a flange F to which the end effector E is attached. The flange F rotates with the rotation of the joint J6. Accordingly, the end effector E attached to the flange F rotates with the rotation of the joint J6. The arm L6 is an example of a first arm. Further, part or all of the arms L1 to L5 are examples of a second arm.

Each of the joints J1 to J6 includes an actuator (not shown). The movable unit A performs actions with the degree of freedom of six axes by cooperative motion of the support B, the end effector E, the arms L1 to L6, and the respective actuators of the joints J1 to J6. That is, the movable unit A having the manipulator M is of a six-axis vertical articulated type. Note that the movable unit A may be adapted to act with the degree of freedom of five or less axes or act with the degree of freedom of seven or more axes.

The actuators of the respective joints J1 to J6 are communicably connected to the robot control apparatus 30 by cables. Thereby, the actuators operate the manipulator M based on the control signals acquired from the robot control apparatus 30. Wired communications via the cables are performed according to standards of e.g. Ethernet (registered trademark), USB, or the like. Or, part or all of the six actuators of the manipulator M may be adapted to be connected to the robot control apparatus 30 via wireless communications performed according to communication standards of Wi-Fi (registered trademark) or the like.

The manipulator M includes a first connector CN1 to which a wiring cable CA of the operation unit 50, which will be described later, can be connected. The first connector CN1 is connected to the robot control apparatus 30 via a wire passing through inside of the robot 20 (i.e., manipulator M and support B). Accordingly, the wiring cable CA of the operation unit 50 is connected to the first connector CN1, and thereby, the operation unit 50 is communicably connected to the robot control apparatus 30. In the example shown in FIG. 1, the first connector CN1 is provided in the arm L4. Note that the first connector CN1 may be provided in a part different from the arm L4 in the manipulator M. Further, the manipulator M may include a second connector different from the first connector CN1 in addition to the first connector CN1. In this case, a user may connect the wiring cable CA to a desired connector. The robot 20 may enable the user to move the manipulator M (that is, enable the user to operate manipulator) by the operation unit 50 including the wiring cable CA having a shorter length than a wiring cable CA when the wiring cable CA is directly connected to the robot control apparatus 30 without using the first connector CN1. As a result, the robot 20 may suppress restriction of the motion of the manipulator M by the wiring cable CA.

The force detection unit 21 is provided in the arm L6. Specifically, the force detection unit 21 is provided (placed) on an opposite surface to a surface to which the end effector E is attached of the surfaces of the flange F in the arm L6. The force detection unit 21 is e.g. a force sensor. The force detection unit 21 detects an external force acting on the end effector E or an object grasped by the end effector E. The external force refers to at least one of force and moment (torque) acting on the end effector E or the object grasped by the end effector E. The force detection unit 21 outputs force detection information containing a value indicating the detected external force as an output value to the robot control apparatus 30 via communications.

The force detection information is used for force control as control based on the force detection information of the movable unit A by the robot control apparatus 30. The force control refers to e.g. compliant motion control such as impedance control. Note that the force detection unit 21 may be another sensor such as a torque sensor that detects an external force applied to the end effector E or an object grasped by the end effector E.

The force detection unit 21 is communicably connected to the robot control apparatus 30 by a cable. Wired communications via the cable are performed according to standards of e.g. Ethernet (registered trademark), USB, or the like. Note that the force detection unit 21 and the robot control apparatus 30 may be adapted to be connected via wireless communications performed according to communication standards of Wi-Fi (registered trademark) or the like.

In the example, the robot control apparatus 30 is a controller that controls (operates) the robot. The robot control apparatus 30 sets a control point T moving with the end effector E in a position previously associated with the end effector E. The control point T is e.g. a TCP (Tool Center Point). The position previously associated with the end effector E is e.g. a position on the rotation axis of the joint J6 rotating the end effector E and the position is apart at a predetermined distance ΔH from the center of gravity of the end effector E toward the side of the finger part of the end effector E. The predetermined distance ΔH is e.g. a distance along the rotation axis from the opposite end to the manipulator M of the ends of the finger part to the center of gravity. Note that the predetermined distance ΔH may be another distance instead. Further, the control point T may be another virtual point such as a virtual point previously associated with a part of the movable unit A in place of the TCP. Or, the control point T may be set to a position in another part of the end effector E in place of that position, or may be set to any position associated with the manipulator M.

The control point T is associated with control point position information as information representing the position of the control point T and control point attitude information as information representing the attitude of the control point T. Note that the control point T may be additionally associated with other information. When the robot control apparatus 30 designates (determines) the control point position information and the control point attitude information, the position and the attitude of the control point T are determined. The robot control apparatus 30 designates the control point position information and operates the movable unit A so that the position of the control point T may coincide with the position represented by the designated control point position information. Further, the robot control apparatus 30 designates the control point attitude information and operates the movable unit A so that the attitude of the control point T may coincide with the attitude represented by the designated control point attitude information.

In the example, the position of the control point T is indicated by a position of the origin of a control point coordinate system TC as a three-dimensional local coordinate system associated with the control point T to move with the control point T in a robot coordinate system RC. Further, the attitude of the control point T is indicated by directions of the respective coordinate axes of the control point coordinate system TC in the robot coordinate system RC.

The robot control apparatus 30 sets the control point T based on control point setting information input from the user in advance. The control point setting information is e.g. information representing relative position and attitude between the position and the attitude of the center of gravity of the end effector E and the position and the attitude of the control point T. Note that the control point setting information may be information representing relative position and attitude between any position and attitude associated with the end effector E and the position and the attitude of the control point T or may be information representing relative position and attitude between any position and attitude associated with the manipulator M and the position and the attitude of the control point T instead.

The robot control apparatus 30 is taught taught point information from the teaching apparatus 40. Specifically, the robot control apparatus 30 acquires the taught point information from the teaching apparatus 40. Then, the robot control apparatus 30 stores the acquired taught point information. The taught point information is information representing a taught point. The taught points are a plurality of virtual points through which the control point T is routed (passed) when the robot control apparatus 30 operates the movable unit A. The taught point is associated with taught point position information and taught point attitude information. The taught point position information is information representing the position of the taught point. Further, the taught point attitude information is information representing the attitude of the taught point.

In the example, the positions of the respective taught points are indicated by positions of the origin of a taught point coordinate system PC as a three-dimensional local coordinate system associated with the respective taught points in the robot coordinate system RC. Further, the attitudes of the taught points are indicated by directions of the respective axes of the taught point coordinate system PC in the robot coordinate system RC. Here, the position and the attitude of the manipulator M in the example are shown by the position and the attitude of the control point T.

The robot control apparatus 30 designates the control point position information representing the position of a certain taught point and the control point attitude information representing the attitude of the taught point based on an operation program stored based on the operation received from the user in advance and the taught point information representing the taught point. Then, the robot control apparatus 30 operates the movable unit A to allow the position of the control point T to coincide with the position represented by the designated control point position information and allow the attitude of the control point T to coincide with the attitude represented by the designated control point attitude information. Thereby, the robot control apparatus 30 allows the position and the attitude of the control point T to coincide with the position and the attitude of the taught point. Further, the robot control apparatus 30 allows the control point T to coincide with the respective taught points based on the operation program in the order designated by the operation program. Therefore, the robot control apparatus 30 may allow the movable unit A to perform a desired action. As a result, the robot control apparatus 30 may allow the robot 20 to perform a predetermined work.

When the position and the attitude of the control point T are changed in the above described manner, the robot control apparatus 30 generates control signals including signals for controlling the actuators of the manipulator M based on an operation program stored based on the operation received from the user in advance and the taught point information acquired from the teaching apparatus 40. The control signals include other signals such as a signal for moving the finger part of the end effector E. Then, the robot control apparatus 30 transmits the generated control signals to the robot 20 and allows the robot 20 to perform a predetermined work.

When an enable switch ES of the operation unit 50 is pressed down to a second position, which will be described later, the robot control apparatus 30 enables movement of the manipulator M by force control (operation of the manipulator M by force control). The enable switch ES is a three-position switch and can be located in one position of a first position, a second position, and a third position. Note that the first position of the enable switch ES is a position in which the enable switch ES is located when the enable switch ES is not pressed down. The third position is a position in which the enable switch ES is located when the enable switch ES is pressed down to the deepest point. The second position is a position between the first position and the third position, in which the enable switch ES is located when the enable switch ES is pressed down to about half (half push).

Specifically, when the enable switch ES is pressed down to the second position, the robot control apparatus 30 acquires the force detection information from the force detection unit 21. The robot control apparatus 30 operates the manipulator M by the force control based on the acquired force detection information and changes the position and the attitude of the control point T. Thereby, the user may allow the position and the attitude of the control point T to coincide with desired position and attitude by moving the position and the attitude of the control point T with hand, and perform direct teaching of teaching the taught point information representing the taught point associated with the taught point position information representing the position and the taught point attitude information representing the attitude to the robot control apparatus 30.

Here, in the force control, the robot control apparatus 30 calculates an amount of displacement based on the external force represented by the force detection information acquired from the force detection unit 21. The amount of displacement is an amount in which the current position and attitude of the control point T are displaced (changed). The robot control apparatus 30 displaces the position and the attitude of the control point T based on the calculated amount of displacement by the amount of displacement. Here, the robot control apparatus 30 calculates the amount of displacement as an amount containing at least one of an amount of translational movement and an amount of rotational movement in which the external force represented by the force detection information is estimated to be zero by displacement of the position and the attitude of the control point T. Note that the calculation method of the amount of displacement may be a known method or a method to be developed. The robot control apparatus 30 may be adapted to calculate an amount of displacement in which the position and the attitude of the control point T are displaced by force control based on output of a torque sensor or a current of a servo motor.

On the other hand, when the enable switch ES of the operation unit 50 is not pressed down, in other words, when the enable switch ES is located in the first position, the robot control apparatus 30 disables movement of the manipulator M by force control (operation of the manipulator M by force control). Specifically, in this case, the robot control apparatus 30 does not operate the manipulator M, and thereby, does not change the position and the attitude of the control point T.

Or, when the enable switch ES of the operation unit 50 is pressed down to the third position, the robot control apparatus 30 brings the robot 20 to an emergency stop. For example, in this case, the robot control apparatus 30 turns off the power switch of the robot 20, and thereby, stops power supply to the robot 20.

In the example, the robot control apparatus 30 is placed outside of the robot 20. Note that the robot control apparatus 30 may have a configuration provided inside of the robot 20 in place of the configuration placed outside of the robot 20.

The teaching apparatus 40 is e.g. a teaching pendant. The teaching apparatus 40 generates taught point information based on the operation received from the user. Note that the teaching apparatus 40 may be adapted to additionally generate taught point information based on a taught point information generation signal from the operation unit 50 relayed by the robot control apparatus 30. When generating the taught point information, the teaching apparatus 40 acquires information representing the current position and attitude of the control point T from the robot control apparatus 30. The teaching apparatus 40 specifies the position and the attitude of the control point T represented by the acquired information as the position and the attitude of the taught point. The teaching apparatus 40 generates taught point information representing the taught point associated with taught point position information representing the specified position of the taught point and taught point attitude information representing the specified attitude of the taught point. The teaching apparatus 40 teaches the generated taught point information to the robot control apparatus 30. That is, the teaching apparatus 40 outputs the taught point information to the robot control apparatus 30 and allows the robot control apparatus 30 to store the taught point information.

The teaching apparatus 40 is communicably connected to the robot control apparatus 30 by a cable. Wired communications via the cable are performed according to standards of e.g. Ethernet (registered trademark), USB, or the like. Note that the teaching apparatus 40 and the robot control apparatus 30 may be adapted to be connected via wireless communications performed according to communication standards of Wi-Fi (registered trademark) or the like.

The operation unit 50 is a member (tool) as a grip (handle) for the user to apply an external force to the end effector E in direct teaching. Note that the operation unit 50 is an example of the handle. The operation unit 50 can be attached and detached in a plurality of positions of the manipulator M. When the operation unit 50 is attached in a certain position of the plurality of positions, the user may grasp (grip) the operation unit 50 attached in the position and apply an external force to the force detection unit 21 of the manipulator M. In direct teaching, the user presses the enable switch ES of the operation unit 50 to the second position with the operation unit 50 grasped. Then, the user applies an external force to the force detection unit 21 by the grasped operation unit 50 with the enable switch ES held down in the second position, and thereby, allows the robot control apparatus 30 to perform force control based on the force detection information acquired from the force detection unit 21. Thereby, the user may allow the position and the attitude of the control point T to coincide with desired position and attitude. That is, the operation unit 50 allows the robot control apparatus 30 to operate the manipulator M by the external force applied by the user and moves (operates) the manipulator M.

Further, as described above, the operation unit 50 includes the wiring cable CA. The wiring cable CA is connected to the first connector CN1, and thereby, the operation unit 50 is communicably connected to the robot control apparatus 30. Wired communications via the wiring cable CA are performed according to standards of e.g. Ethernet (registered trademark), USB, or the like. Note that the operation unit 50 and the robot control apparatus 30 may be adapted to be connected via wireless communications performed according to communication standards of Wi-Fi (registered trademark) or the like.

As described above, the robot 20 includes the manipulator M and the operation unit 50 moving (operating) the manipulator M can be attached and detached in the plurality of positions of the manipulator M. Thereby, in direct teaching, the robot 20 may enable the user to move the manipulator M (the user to operate the manipulator M) by the operation unit 50 attached to a desired position of the plurality of positions of the manipulator M. As below, details of the operation unit 50 and the plurality of positions in which the operation unit 50 can be attached and detached will be specifically explained.

### Details of Operation Unit

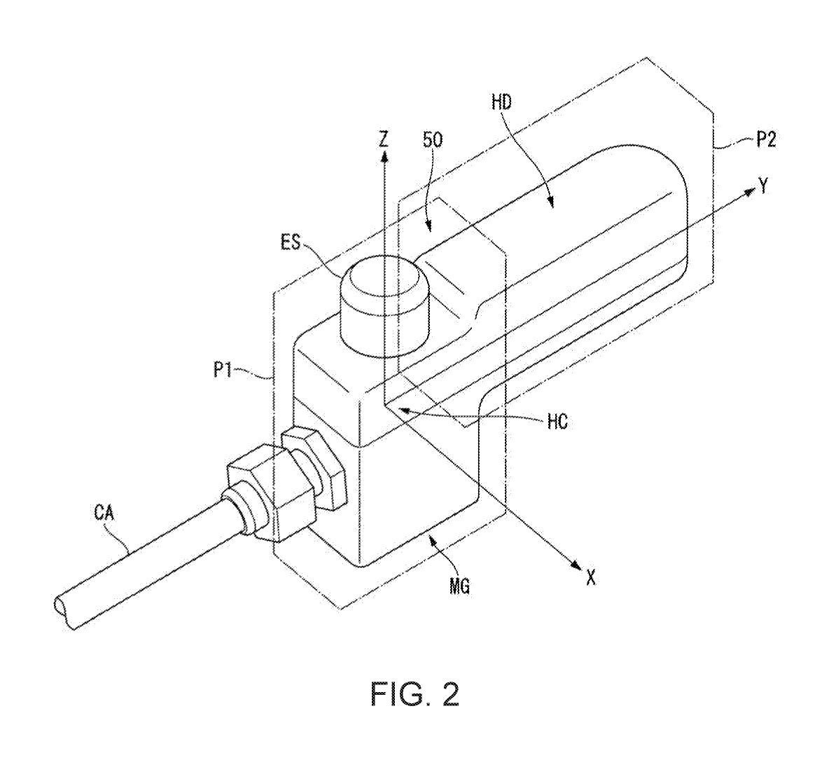

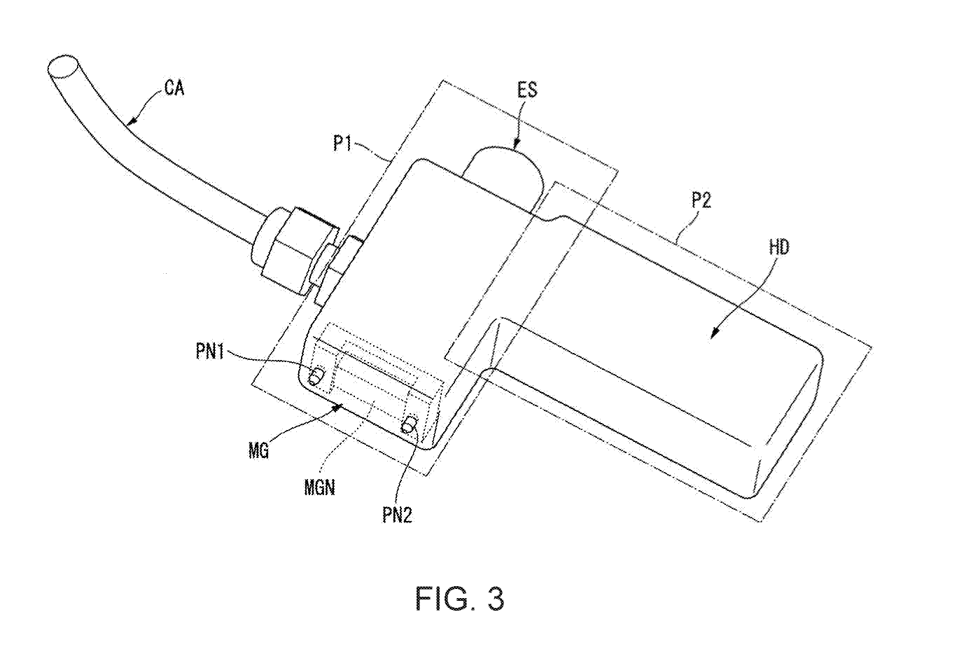

As below, referring to FIGS. 2 to 4, the details of the operation unit 50 will be explained. FIG. 2 is a perspective view of an example of the operation unit 50. FIG. 3 is a perspective view when the operation unit 50 shown in FIG. 2 is seen from another angle. As shown in FIGS. 2 and 3, the operation unit 50 includes a first part P1 extending in a direction in which the above described enable switch ES can be pressed down and a second part P2 extending in a direction orthogonal to the direction in which the first part P1 extends. Here, in the operation unit 50 in the example, a plurality of corners on the surfaces of the first part P1 and a plurality of corners on the surfaces of the second part P2 are respectively rounded. However, part or all of these corners may not necessarily be rounded.

The first part P1 includes the above described enable switch ES and an attaching and detaching part MG.

As described above, the enable switch ES is the three-position switch that can be located in one of the first position, the second position, and the third position. When the enable switch ES is not pressed down by the user, the operation unit 50 allows the robot control apparatus 30 to disable movement of the manipulator M (operation of the manipulator M). The enable switch ES is pressed down from the first position to the second position by the user, and thereby, the operation unit 50 allows the robot control apparatus 30 to enable movement of the manipulator M by force control (operation the manipulator M by force control). The enable switch ES is pressed down from the first position or second position to the third position by the user, and thereby, the operation unit 50 allows the robot control apparatus 30 to bring the robot 20 to an emergency stop.

Note that, after the enable switch ES is pressed down to the third position and the robot 20 is brought to an emergency stop by the user, the operation unit 50 may be adapted to allow the robot control apparatus 30 to release the emergency stop of the robot 20 and restart the robot 20 when the enable switch ES is pressed down from the first position or second position to the third position repeatedly at a predetermined number of times (repeatedly hit) within a predetermined time by the user. Thereby, the user may shorten the time taken for restarting the robot 20. Here, the predetermined time is about two seconds, however, may be another time, not limited to that. The predetermined number of times is about three, however, may be another number of times, not limited to that.

The attaching and detaching part MG is provided on the opposite end to the enable switch ES of the ends of the first part P1. The attaching and detaching part MG is a part that attaches the operation unit 50 to the manipulator M of the parts of the operation unit 50. In the example, the attaching and detaching part MG includes a magnet MGN and a first pin PN1 and a second pin PN2 as two pins. When attaching the operation unit 50 to the manipulator M, the attaching and detaching part MG allows the magnet MGN to attract the operation unit 50 to the part to and from which the operation unit 50 can be attached and detached of the parts of the manipulator M and fixes the position of the operation unit 50. Further, in this case, the attaching and detaching part MG fixes the attitude of the operation unit 50 by insertion of the respective first pin PN1 and second pin PN2 into the parts. Note that the operation unit 50 may have another configuration such a configuration to be attached to the manipulator M using screws and bolts or the like, a configuration to be attached to the manipulator M using a shaft with key, a configuration to be attached to the manipulator M using a plug and a jack, or a configuration to be attached to the manipulator M using a lock mechanism for fixing the operation unit 50 to the manipulator M in place of the attaching and detaching part MG. In the case of the lock mechanism, a button for attachment and detachment of the manipulator M and the operation unit 50 may be provided in at least one of the operation unit 50 and the manipulator M.

The second part P2 is a grip part HD itself in the example.

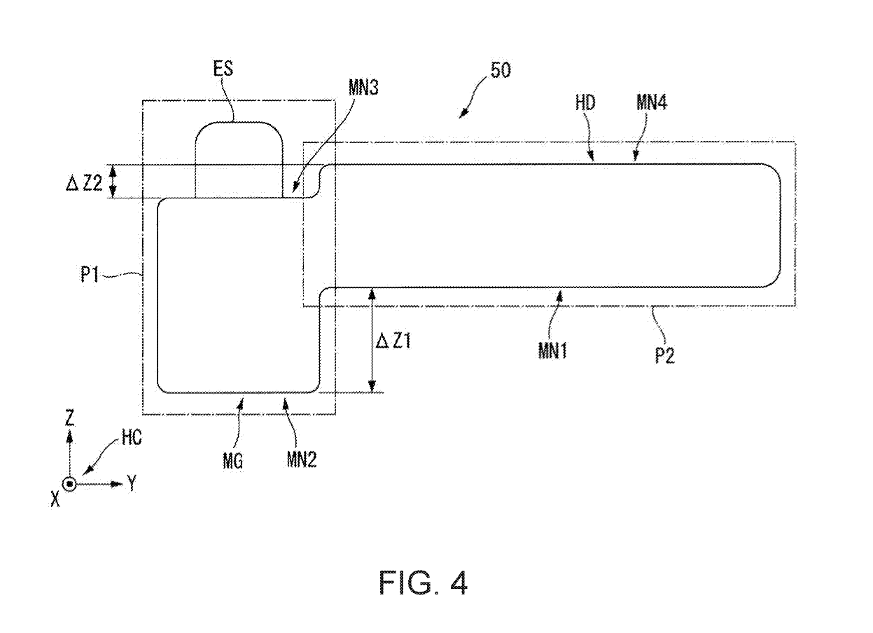

The grip part HD is a part to be grasped (gripped) by the user with hand in direct teaching, i.e., a part having a role of a grip (handle). The grip part HD extends in a direction crossing the rotation axis of the arm L6 (i.e., the rotation axis of the joint J6). Specifically, in the example, the grip part HD extends in a positive direction of a Y-axis in a three-dimensional local coordinate system HC when a direction from the flange F toward the end effector E is a positive direction of an X-axis and the opposite direction to the direction in which the enable switch ES is pressed down is a positive direction of a Z-axis of directions along the rotation axis as shown in FIG. 4. FIG. 4 is a side view of the operation unit 50 when the operation unit 50 shown in FIG. 2 is seen from the positive direction toward the negative direction of the X-axis in the three-dimensional local coordinate system HC. Note that the grip part HD may be adapted to extend in another direction crossing the rotation axis of the arm L6 (i.e., the rotation axis of the joint J6) in place of the positive direction of the Y-axis.

Further, of the surfaces of the grip part HD, a first surface MN1 as a surface on the negative-direction side of the Z-axis in the three-dimensional local coordinate system HC shown in FIG. 4 extends from a position apart at a predetermined distance ΔZ1 in the positive direction of the Z-axis from a second surface MN2 as a surface on which the first pin PN1 and the second pin PN2 are provided of the surfaces of the first part P1 in the positive direction of the Y-axis in the three-dimensional local coordinate system HC. The predetermined distance ΔZ1 is e.g. 30 millimeters. Note that the predetermined distance ΔZ1 may be another distance in a range from about 20 to 50 millimeters. Here, a space between the first surface MN1 and the second surface MN2 in the operation unit 50 is a space in which the user puts a finger when gripping the grip part HD.

Further, a surface MN3 on which the enable switch ES is provided of the surfaces of the first part P1 is a part at a predetermined distance ΔZ2 in the negative direction of the Z-axis from a fourth surface MN4 as a surface on the positive direction side of the Z-axis in the three-dimensional local coordinate system HC shown in FIG. 4 of the surfaces of the grip part HD. The predetermined distance ΔZ2 is e.g. 11 millimeters. Note that the predetermined distance ΔZ2 may be another distance in a range from about 5 to 15 millimeters. Here, a level difference between the third surface MN3 and the fourth surface MN4 in the operation unit 50 is provided so that the user may easily press down the enable switch ES with the grip part HD grasped. Thereby, the operation unit 50 may suppress fatigue of the user's finger that presses down the enable switch ES. Note that the level difference is not necessarily provided (that is, the predetermined distance ΔZ2 may be zero millimeters).

The operation unit 50 may include various buttons in addition to the configuration described as above. For example, the operation unit 50 may include a button for teaching the taught point information representing the taught point associated with the taught point position information representing the current position of the control point T and the taught point attitude information representing the current attitude of the control point T to the robot control apparatus 30. In this case, when the button is pressed down by the user, the operation unit 50 outputs the above described taught point information generation signal to the robot control apparatus 30 and allows the robot control apparatus 30 to relay the taught point information generation signal to the teaching apparatus 40. The teaching apparatus 40 to which the taught point information has been relayed from the robot control apparatus 30 (that has acquired the taught point information) acquires the current position and attitude of the control point T from the robot control apparatus 30 and generates taught point information associated with the acquired taught point position information representing the position and taught point attitude information representing the attitude. The teaching apparatus 40 outputs the generated taught point information to the robot control apparatus 30 and allows the robot control apparatus 30 to store the taught point information. As described above, in this case, the operation unit 50 can allow the robot control apparatus 30 to store at least one of the position and the attitude of the manipulator M, i.e., the position and the attitude of the control point T.

When the robot 20 has a redundant axis (redundant degree of freedom), the operation unit 50 may include a button for rotating the redundant axis. The case is e.g. the case where the robot 20 has a seven-axis vertical articulated movable unit. That is, the operation unit 50 having the button operates the arm having the redundant axis of the movable unit of the seven or more arms of the movable unit. The button is an example of a redundant axis operation part. In this case, the movable unit includes joints JS1 to JS7 as seven joints and seven arms. The joint JS1 is the joint closest to the support B and the joint JS7 is the joint closest to the end effector E. In the movable unit, the seven joints are provided in the order of the joint JS1, joint JS2, joint JS3, joint JS4, joint JS5, joint JS6, and joint JS7 from the support B side toward the end effector E side. The redundant axis in the movable unit refers to a rotation axis of an object plane with respect to a reference plane. The object plane is a plane containing a triangle formed by connection of the respective joint JS2, joint JS4, joint JS6 of the joints of the movable unit by straight lines.

The operation unit 50 may include buttons for respectively rotating part or all of the joints J1 to J6 of the robot 20.

The operation unit 50 may include a touch panel. In this case, for example, various buttons including the above described buttons may be displayed on the touch panel. Further, in this case, the operation unit 50 may provide part or all of the functions of the teaching apparatus 40 to the user using the touch panel. Thereby, in the robot system 1, the taught point information may be taught to the robot control apparatus 30 without using the teaching apparatus 40.

Positions in which Operation Unit can be Attached and Detached in Manipulator

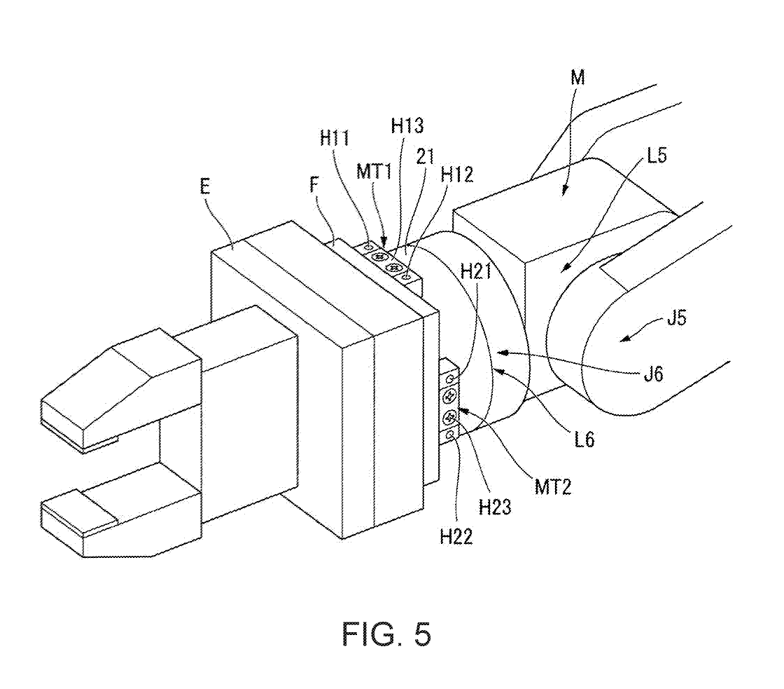

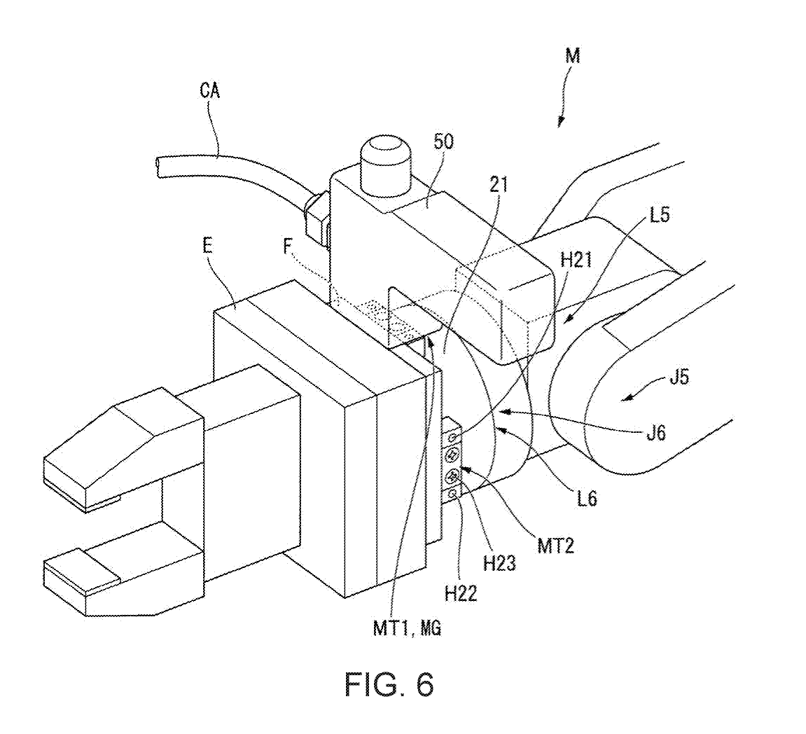

As below, referring to FIGS. 5 and 6, the plurality of positions in which the operation unit 50 can be attached and detached in the manipulator M will be explained.

As described above, the manipulator M has the arm L6. The flange F of the arm L6 includes an attachment and detachment part MT1 to and from which the operation unit 50 can be attached and detached, an attachment and detachment part MT2 different from the attachment and detachment part MT1 to and from which the operation unit 50 can be attached and detached, and an attachment and detachment part MT3 different from the attachment and detachment part MT1 or attachment and detachment part MT2 to and from which the operation unit 50 can be attached and detached. That is, in the manipulator M, there are the attachment and detachment parts to and from which the operation unit 50 can be attached and detached (i.e., the attachment and detachment parts MT1 to MT3) closer to the distal end than the force detection unit 21. The attachment and detachment part MT1 is an example of a first attachment and detachment part. The respective attachment and detachment parts MT2 and MT3 are examples of a second attachment and detachment part.

FIG. 5 is a perspective view of an example of the flange F to which the end effector E is attached. In FIG. 5, the attachment and detachment part MT3 is provided on the back side of the flange F and not shown. In the example shown in FIG. 5, the flange F is a square flat-plate flange with rounded corners, however, may be a flange having another shape such as a circular flat-plate flange. On a certain side surface of the four side surfaces of the flange F, the attachment and detachment part MT1 is provided. The attachment and detachment part MT1 has a first concave portion H11 in which the first pin PN1 of the attaching and detaching part MG of the operation unit 50 is fitted, a second concave portion H12 in which the second pin PN2 of the attaching and detaching part MG is fitted, and a metal portion H13 attracted by the magnet MGN of the attaching and detaching part MG by a magnetic force. Note that the arm L6 may include an attachment and detachment part that can attach and detach the operation unit 50 to and from another part than the flange F, may include four or more of the attachment and detachment parts, or may include only two of the attachment and detachment parts.

On the side surface adjacent to the side surface on which the attachment and detachment part MT1 is provided of the four side surfaces of the flange F, the attachment and detachment part MT2 is provided. The attachment and detachment part MT2 has a first concave portion H21 in which the first pin PN1 of the attaching and detaching part MG of the operation unit 50 is fitted, a second concave portion H22 in which the second pin PN2 of the attaching and detaching part MG is fitted, and a metal portion H23 attracted by the magnet MGN of the attaching and detaching part MG by a magnetic force.

On the side surface adjacent to the side surface on which the attachment and detachment part MT2 is provided of the four side surfaces of the flange F, the attachment and detachment part MT3 is provided. The attachment and detachment part MT3 has a first concave portion H31 in which the first pin PN1 of the attaching and detaching part MG of the operation unit 50 is fitted, a second concave portion H32 in which the second pin PN2 of the attaching and detaching part MG is fitted, and a metal portion H33 attracted by the magnet MGN of the attaching and detaching part MG by a magnetic force.

As described above, the flange F of the manipulator M includes the plurality of attachment and detachment parts that can be attached to and detached from the operation unit 50 are provided, and the robot 20 may enable the user to move the manipulator M using the operation unit 50 attached to a desired attachment and detachment part (allow the user to operate the manipulator M).

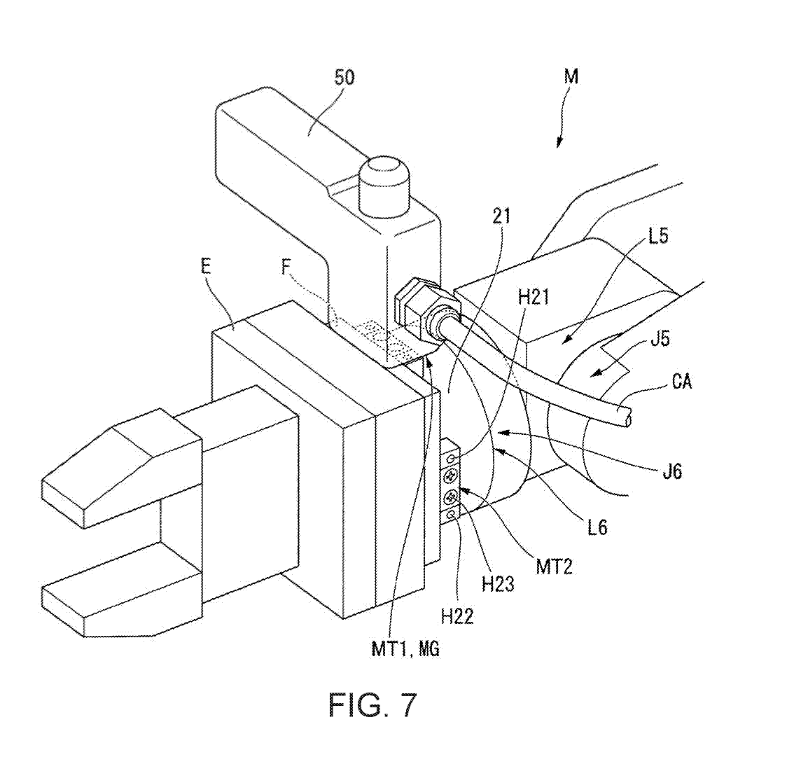

FIG. 6 shows an example of a state in which the operation unit 50 is attached to the attachment and detachment part MT1 shown in FIG. 5. As shown in FIG. 6, the attaching and detaching part MG is attached to the attachment and detachment part MT1 of the flange F of the arm L6, and thereby, the operation unit 50 is attached to the manipulator M. Here, when the operation unit 50 is attached to the attachment and detachment part MT1, the operation unit 50 may be attached to the attachment and detachment part MT1 in an attitude different from the attitude of the operation unit 50 shown in FIG. 6. For example, the operation unit 50 may be attached to the attachment and detachment part MT1 in the attitude shown in FIG. 7. FIG. 7 shows an example of a state in which the operation unit 50 is attached to the attachment and detachment part MT1 in the attitude different from the attitude of the operation unit 50 shown in FIG. 6. Note that the attitude of the operation unit 50 is indicated by directions of the respective coordinate axes of the above described three-dimensional local coordinate system HC in the robot coordinate system RC. The attitude of the operation unit 50 shown in FIG. 7 is an attitude obtained by rotation of the attitude of the operation unit 50 shown in FIG. 6 by 180° about the Z-axis in the three-dimensional local coordinate system HC. That is, the operation unit 50 may be attached in two attitudes different from each other to the attachment and detachment part MT1. One of the two attitudes is an example of a first attitude and the other is an example of a second attitude. Note that the operation unit 50 may be adapted to be attached in three or more attitudes to the attachment and detachment part MT1. For example, the operation unit 50 may be adapted to be rotated about the Z-axis with respect to the attachment and detachment part MT1.

When the operation unit 50 is attached to the attachment and detachment part MT2, the operation unit 50 may be attached to the attachment and detachment part MT2 in two attitudes different from each other as is the case of the operation unit 50 attached to the attachment and detachment part MT1. When the operation unit 50 is attached to the attachment and detachment part MT3, the operation unit 50 may be attached to the attachment and detachment part MT3 in two attitudes different from each other as is the case of the operation unit 50 attached to the attachment and detachment part MT1. The explanation of the attachment and detachment part MT2 and the attachment and detachment part MT3 is the same as that of the attachment and detachment part MT1 and will be omitted.

Note that, when torque sensors are provided in part or all of the joints J1 to J6, the operation unit 50 may be attached to and detached from a part in which an external force may be applied to the joint provided with the torque sensor. For example, when the torque sensor is provided in the joint J5, the arm L5 of the robot 20 includes an attachment and detachment part MT4 to and from which the operation unit 50 can be attached and detached. In this case, in direct teaching, the robot control apparatus 30 performs the above described force control based on the external force applied to the torque sensor by the user using the operation unit 50. The arm L5 is an example of a second arm. Further, the attachment and detachment part MT4 is an example of a third attachment and detachment part. Note that, in this case, the attachment and detachment part MT4 may be provided in any part closer to the end effector E side than the torque sensor of the parts of the manipulator M in place of the arm L5.

Or, the robot 20 may include an attachment and detachment part to and from which the operation unit 50 can be attached and detached on a surface out of the operation range of the robot 20 of the surfaces of the robot 20. The operation range of the robot 20 refers to a range that can be reached by the end effector E by movement of the control point T. For example, the surface out of the operation range is the back surface of the robot 20. Thereby, it is unnecessary for the robot 20 to secure a space for mounting the operation unit 50 in another location even when the operation unit 50 is not used.

In the robot system 1, the user may move the manipulator M with one hand (operate the manipulator M with one hand) using the operation unit 50 that can be attached to and detached from the manipulator M of the robot 20. Further, the user may perform another work with the other hand not grasping the operation unit 50. As a result, the user may improve efficiency of the work for the robot 20.

Further, in the robot system 1, the manipulator includes the plurality of attachment and detachment parts to and from which the operation unit 50 can be attached and detached, and the operation unit 50 may be attached to a desired attachment and detachment part according to the surrounding environment of the robot 20. Thereby, the robot 20 may enable the user to move the manipulator M (allow the user to operate the manipulator M) using the operation unit 50 attached to the desired position of the plurality of positions of the manipulator M.

Note that, in the above description, the case where the operation unit 50 is used by the user in direct teaching is explained, however, the subject for which the operation unit 50 is used is not limited to direct teaching. For example, when the robot 20 is brought to an emergency stop within a region in which the control point T is surrounded by another object, the user may use the operation unit 50 for moving the control point T to a region not surrounded by the other object.

### Modified Example of Embodiment

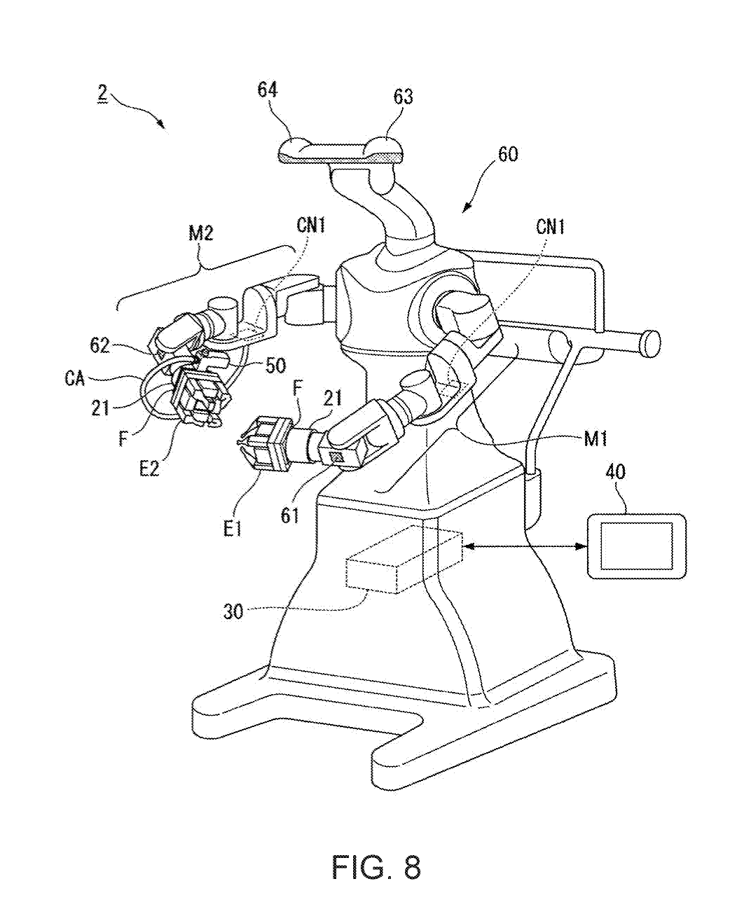

As below, referring to FIG. 8, a modified example of the embodiment will be explained. Note that, in the modified example of the embodiment, the same configuration parts as those of the embodiment have the same signs and their explanation will be omitted.

FIG. 8 shows an example of a configuration of a robot system 2 according to the modified example of the embodiment. The robot system 2 includes a robot 60 containing the robot control apparatus 30, the teaching apparatus 40, and the operation unit 50.

The robot 60 is a dual-arm robot including a first movable unit, a second movable unit, a support supporting the first movable unit and the second movable unit, and the robot control apparatus 30. The dual-arm robot is a robot having two movable units (arms) like the first movable unit and the second movable unit in the example. Note that the robot 60 may be a multi-arm robot having three or more arms in place of the dual-arm robot.

The first movable unit includes a first end effector E1 and a first manipulator M1.

The first end effector E1 is an end effector having a finger part that can grasp an object in the example. Note that the first end effector E1 may be another end effector that can lift an object using suction by air, a magnetic force, a jig, or the like in place of the end effector having the finger part.

The first end effector E1 is communicably connected to the robot control apparatus 30 by a cable. Thereby, the first end effector E1 performs actions according to control signals acquired from the robot control apparatus 30. Wired communications via the cable are performed according to standards of e.g. Ethernet (registered trademark), USB, or the like. Or, the first end effector E1 may be adapted to be connected to the robot control apparatus 30 via wireless communications performed according to communication standards of Wi-Fi (registered trademark) or the like.

The first manipulator M1 has seven joints, seven arms (link members), the force detection unit 21, and a first imaging unit 61. Further, each of the seven joints has an actuator (not shown). That is, the first movable unit having the first manipulator M1 is of a seven-axis vertical articulated type. The first movable unit performs actions with the degree of freedom of seven axes by cooperative motion of the support, the first end effector E1, the seven arms of the first manipulator M1, and the respective actuators of the seven joints of the first manipulator M1. Note that the first movable unit may be adapted to act with the degree of freedom of six or less axes or act with the degree of freedom of eight or more axes.

When the first movable unit acts with the degree of freedom of seven axes, the number of attitudes that can be taken is larger than that in the case where the first movable unit acts with the degree of freedom of six or less axes. Thereby, the first movable unit may smoothly move and easily avoid interferences with objects existing around the first movable unit, for example. Further, when the first movable unit acts with the degree of freedom of seven axes, control of the first movable unit is easier than that in the case where the first movable unit acts with the degree of freedom of eight or more axes because the calculation amount is less.

The seven actuators (of the joints) of the first manipulator M1 are respectively communicably connected to the robot control apparatus 30 by cables. Thereby, the actuators operate the first manipulator M1 based on the control signals acquired from the robot control apparatus 30. Wired communications via the cables are performed according to standards of e.g. Ethernet (registered trademark), USB, or the like. Or, part or all of the seven actuators of the first manipulator M1 may be adapted to be connected to the robot control apparatus 30 via wireless communications performed according to communication standards of Wi-Fi (registered trademark) or the like.

The first imaging unit 61 is a camera including e.g. a CCD (Charge Coupled Device), CMOS (Complementary Metal Oxide Semiconductor), or the like as an imaging device that converts collected lights into electrical signals. In the example, the first imaging unit 61 is provided in a part of the first manipulator M1. Accordingly, the first imaging unit 61 moves according to the motion of the first movable unit. Further, the range that can be imaged by the first imaging unit 61 changes according to the motion of the first movable unit. The first imaging unit 61 may be adapted to capture a still image of the range or a moving image of the range.

Further, the first imaging unit 61 is communicably connected to the robot control apparatus 30 by a cable. Wired communications via the cable are performed according to standards of e.g. Ethernet (registered trademark), USB, or the like. Note that the first imaging unit 61 may be adapted to be connected to the robot control apparatus 30 via wireless communications performed according to communication standards of Wi-Fi (registered trademark) or the like.

Here, the first movable unit has the same configuration as that of the movable unit A according to the embodiment in addition to the configuration explained as above (e.g. the flange F of the arm closest to the first end effector E1 of the arms of the first movable unit, the first connector CN1, the attachment and detachment parts MT1 to MT3 not shown in FIG. 8, etc.). Accordingly, the explanation of the same configurations as those of the movable unit A of the configurations of the first movable unit will be omitted.

The second movable unit includes a second end effector E2 and a second manipulator M2.

The second end effector E2 is an end effector having a finger part that can grasp an object in the example. Note that the second end effector E2 may be another end effector that can lift an object using suction by air, a magnetic force, a jig, or the like in place of the end effector having the finger part.

The second end effector E2 is communicably connected to the robot control apparatus 30 by a cable. Thereby, the second end effector E2 performs actions according to control signals acquired from the robot control apparatus 30. Wired communications via the cable are performed according to standards of e.g. Ethernet (registered trademark), USB, or the like. Or, the second end effector E2 may be adapted to be connected to the robot control apparatus 30 via wireless communications performed according to communication standards of Wi-Fi (registered trademark) or the like.

The second manipulator M2 has seven joints, seven arms (link members), the force detection unit 21, and a second imaging unit 62. Further, each of the seven joints has an actuator (not shown). That is, the second movable unit having the second manipulator M2 is a seven-axis vertical articulated arm. The second movable unit performs actions with the degree of freedom of seven axes by cooperative motion of the support, the second end effector E2, the seven arms of the second manipulator M2, and the respective actuators of the seven joints of the second manipulator M2. Note that the second movable unit may be adapted to act with the degree of freedom of six or less axes or act with the degree of freedom of eight or more axes.

When the second movable unit acts with the degree of freedom of seven axes, the number of attitudes that can be taken is larger than that in the case where the second movable unit acts with the degree of freedom of six or less axes. Thereby, the second movable unit may smoothly move and easily avoid interferences with objects existing around the second movable unit, for example. Further, when the second movable unit acts with the degree of freedom of seven axes, control of the second movable unit is easier than that in the case where the second movable unit acts with the degree of freedom of eight or more axes because the calculation amount is less.

The seven actuators (of the joints) of the second manipulator M2 are respectively communicably connected to the robot control apparatus 30 by cables. Thereby, the actuators operate the second manipulator M2 based on the control signals acquired from the robot control apparatus 30. Wired communications via the cables are performed according to standards of e.g. Ethernet (registered trademark), USB, or the like. Or, part or all of the seven actuators of the second manipulator M2 may be adapted to be connected to the robot control apparatus 30 via wireless communications performed according to communication standards of Wi-Fi (registered trademark) or the like.

The second imaging unit 62 is a camera including e.g. a CCD, a CMOS, or the like as an imaging device that converts collected lights into electrical signals. In the example, the second imaging unit 62 is provided in a part of the second manipulator M2. Accordingly, the second imaging unit 62 moves according to the motion of the second movable unit. Further, the range that can be imaged by the second imaging unit 62 changes according to the motion of the second movable unit. The second imaging unit 62 may be adapted to capture a still image of the range or a moving image of the range.

Further, the second imaging unit 62 is communicably connected to the robot control apparatus 30 by a cable. Wired communications via the cable are performed according to standards of e.g. Ethernet (registered trademark), USB, or the like. Note that the second imaging unit 62 may be adapted to be connected to the robot control apparatus 30 via wireless communications performed according to communication standards of Wi-Fi (registered trademark) or the like.

Here, the second movable unit has the same configuration as that of the movable unit A according to the embodiment in addition to the configuration explained as above (e.g. the flange F of the arm closest to the second end effector E2 of the arms of the second movable unit, the first connector CN1, the attachment and detachment parts MT1 to MT3 not shown in FIG. 8, etc.). Accordingly, the explanation of the same configurations as those of the movable unit A of the configurations of the second movable unit will be omitted. Note that, in the example shown in FIG. 8, the operation unit 50 is attached to the attachment and detachment part MT1 of the second movable unit. Accordingly, in FIG. 8, the wiring cable CA of the operation unit 50 is connected to the first connector CN1 of the second movable unit (in FIG. 8, the first connector CN1 is located on the back side of the second movable unit and not seen).

Further, the robot 60 includes a third imaging unit 63 and a fourth imaging unit 64.

The third imaging unit 63 is a camera including e.g. a CCD, CMOS, or the like as an imaging device that converts collected lights into electrical signals. The third imaging unit 63 is provided in a part in which stereo imaging of the range that can be captured by the fourth imaging unit 64 can be performed with the fourth imaging unit 64. The third imaging unit 63 is communicably connected to the robot control apparatus 30 by a cable. Wired communications via the cable are performed according to standards of e.g. Ethernet (registered trademark), USB, or the like. Note that the third imaging unit 63 may be adapted to be connected to the robot control apparatus 30 via wireless communications performed according to communication standards of Wi-Fi (registered trademark) or the like.

The fourth imaging unit 64 is a camera including e.g. a CCD, CMOS, or the like as an imaging device that converts collected lights into electrical signals. The fourth imaging unit 64 is provided in a part in which stereo imaging of the range that can be captured by the third imaging unit 63 can be performed with the third imaging unit 63. The fourth imaging unit 64 is communicably connected to the robot control apparatus 30 by a cable. Wired communications via the cable are performed according to standards of e.g. Ethernet (registered trademark), USB, or the like. Note that the fourth imaging unit 64 may be adapted to be connected to the robot control apparatus 30 via wireless communications performed according to communication standards of Wi-Fi (registered trademark) or the like.

In the example, the above described respective functional parts of the robot 60 acquire control signals from the robot control apparatus 30 provided in the robot 60. Then, the respective functional parts perform actions based on the acquired control signals. Note that the robot 60 may be adapted to be controlled by the robot control apparatus 30 provided outside in place of the configuration containing the robot control apparatus 30. In this case, the robot 60, the robot control apparatus 30, the teaching apparatus 40, and the operation unit 50 form the robot system. Or, the robot 60 may have a configuration without part or all of the first imaging unit 61, the second imaging unit 62, the third imaging unit 63, and the fourth imaging unit 64.

According to the above described configuration, the operation unit 50 can be attached and detached in the plurality of positions of the first manipulator M1 and can be attached and detached in the plurality of positions of the second manipulator M2. Thereby, the robot 60 may enable the user to move the first manipulator M1 (allow the user to operate the first manipulator M1) using the operation unit 50 attached to a desired position of the plurality of positions of the first manipulator M1 and may enable the user to move the second manipulator M2 (allow the user to operate the second manipulator M2) using the operation unit 50 attached to the desired position of the plurality of positions of the second manipulator M2.

As described above, regarding the robot (in the example, the robot 20, robot 60), the handle (in the example, the operation unit 50) for moving the manipulator (in the example, the manipulator M, first manipulator M1, second manipulator M2) can be attached and detached in the plurality of positions of the manipulator. Thereby, the robot may enable the user to move the manipulator using the handle attached to a desired position of the plurality of positions of the manipulator.

In the robot, the wiring cable of the handle (in the example, the wiring cable CA) is connectable using the first connector (in the example, the first connector CN1) provided in the manipulator of the robot. Thereby, the robot may enable the user to move the manipulator using the handle with the short wiring cable.

Further, in the robot, the wiring cable of the handle is connectable using the second connector provided in the manipulator of the robot. Thereby, the robot may enable the user to move the manipulator using the handle with the wiring cable connected to a desired connector.

In the robot, the first arm (in the example, the arm L6) includes the first attachment and detachment part (in the example, the attachment and detachment part MT1) to and from which the handle can be attached and detached, and the second attachment and detachment part different from the first attachment and detachment part (in the example, the attachment and detachment part MT2) to and from which the handle can be attached and detached. Thereby, the robot may enable the user to move the manipulator using the handle attached to a desired attachment and detachment part.

Further, in the robot, the first arm is located on the distal end of the plurality of arms of the manipulator. Thereby, the robot may enable the user to move the manipulator using the handle attached to the first arm located on the distal end of the plurality of arms of the manipulator.

In the robot, the handle has the grip part (in the example, the grip part HD) extending in the direction crossing the rotation axis of the first arm (in the example, the rotation axis of the joint J6). Thereby, the robot may enable the user to move the manipulator using the handle having the grip part extending in the direction crossing the rotation axis of the first arm.

Further, in the robot, the handle is provided in the first attitude or second attitude in the first attachment and detachment part. Thereby, the robot may enable the user to move the manipulator using the handle attached to the first attachment and detachment part in a desired attitude.

The robot includes the force detection unit (in the example, the force detection unit 21) provided in the manipulator. Thereby, the robot may enable the user to move the manipulator by applying a force to the force detection unit using the handle.

The robot includes the attachment and detachment part to and from which the handle can be attached and detached closer to the distal end than the force detection unit. Thereby, the robot may enable the user to move the manipulator by applying a force to the force detection unit using the handle attached closer to the distal end than the force detection unit.

In the robot, the second arm (in the example, the arm L5) has the third attachment and detachment part to and from which the handle can be attached and detached. Thereby, the robot may enable the user to move the manipulator using the handle attached to the third attachment and detachment part of the second arm (in the example, the attachment and detachment part MT4).

In the robot, the manipulator has the seven or more arms. Thereby, the robot may enable the user to move the manipulator using the handle attached to a desired position of the plurality of positions of the manipulator having the seven or more arms.

In the robot, the handle includes the redundant axis operation part for operating the arm having the redundant axis of the manipulator of the seven or more arms. Thereby, the robot may enable the user to rotate the redundant axis to a desired rotation angle using the redundant axis operation part.

Further, in the robot, the handle is provided with the enable switch (in the example, the enable switch ES) that enables movement of the manipulator. Thereby, the movement of the manipulator is enabled by the enable switch, and the robot may enable the user to move the manipulator using the handle.

In the robot, the enable switch can be located in the first position, the second position, and the third position. When the enable switch is located in the second position, the movement of the manipulator is enabled and the second position is located between the first position and the third position. Thereby, the movement of the manipulator is enabled by the enable switch located in the second position, and the robot may enable the user to move the manipulator using the handle.

In the robot, the handle can allow the robot control apparatus to store at least one of the position and the attitude of the manipulator. Thereby, the robot may perform a work based on at least one of the position and the attitude of the manipulator stored in the robot control apparatus using the handle.

In the robot (in the example, the robot 60), as the manipulators, the first manipulator (in the example, the first manipulator M1) and the second manipulator (in the example, the second manipulator M2) different from the first manipulator are provided. Thereby, the robot may enable the user to move the first manipulator using the handle attached to a desired position of the plurality of positions of the first manipulator, and enable the user to move the second manipulator using the handle attached to a desired position of the plurality of positions of the second manipulator.

As above, the embodiments of the invention are described with reference to the drawings, however, the specific configurations are not limited to the embodiments and changes, replacements, deletions, etc. may be made without departing from the scope of the invention.

A program for realizing a function of an arbitrary configuration part in the above described apparatus (e.g. the robot control apparatus 30, teaching apparatus 40, operation unit 50) may be recorded in a computer-readable recording medium and the program may be read into a computer system and executed. Note that “computer system” here includes an OS (Operating System) and hardware such as peripherals. Further, “computer-readable recording medium” refers to a portable medium such as a flexible disk, magnetooptical disk, ROM, CD (Compact Disk)-ROM and a storage device such as a hard disk built in the computer system. Furthermore, “computer-readable recording medium” includes a medium that holds a program in a fixed period such as a volatile memory (RAM) within the computer system serving as a server or client when the program is transmitted via a network such as the Internet or a communication line such as a phone line.

The program may be transmitted from the computer system in which the program is stored in a memory device or the like via a transmission medium or transmission wave within the transmission medium to another computer system. Here, “transmission medium” for transmission of the program refers to a medium having a function of transmitting information including a network (communication network) such as the Internet and a communication line such as a phone line.

Further, the program may be for realization of part of the above described functions. Furthermore, the program may be for realization of the above described function in combination with a program that has been already recorded in the computer system, the so-called differential file (differential program).

The entire disclosure of Japanese Patent Application No. 2016-149423, filed Jul. 29, 2016 is expressly incorporated by reference herein.

What is claimed is:

1. A robot comprising a manipulator,
wherein a handle for moving the manipulator is capable of being attached and detached in a plurality of positions of the manipulator.

2. The robot according to claim 1, wherein the handle includes a wiring cable, and
the wiring cable is connectable using a first connector provided in the manipulator of the robot.

3. The robot according to claim 2, wherein the wiring cable is connectable using a second connector provided in the manipulator of the robot.

4. The robot according to claim 1, wherein the manipulator includes a first arm,
wherein the first arm includes a first attachment and detachment part to and from which the handle is capable of being attached and detached, and a second attachment and detachment part different from the first attachment and detachment part to and from which the handle is capable of being attached and detached.

5. The robot according to claim 4, wherein the first arm is located on a distal end of a plurality of arms of the manipulator.

6. The robot according to claim 4, wherein the handle has a grip part extending in a direction crossing a rotation axis of the first arm.

7. The robot according to claim 4, wherein the handle is provided in a first attitude or second attitude in the first attachment and detachment part.

8. The robot according to claim 1, further comprising a force detection unit provided in the manipulator.

9. The robot according to claim 8, wherein an attachment and detachment part to and from which the handle is capable of being attached and detached is provided closer to the distal end than the force detection unit.

10. The robot according to claim 1, wherein the manipulator includes a second arm, and
the second arm has a third attachment and detachment part to and from which the handle is capable of being attached and detached.

11. The robot according to claim 1, wherein the manipulator has seven or more arms.

12. The robot according to claim 11, wherein the handle includes a redundant axis operation part for operating the arm having a redundant axis of the manipulator of the seven or more arms.

13. The robot according to claim 1, wherein the handle is provided with an enable switch that enables movement of the manipulator.

14. The robot according to claim 13, wherein the enable switch is capable of being located in a first position, a second position, and a third position, and, when the enable switch is located in the second position, the movement of the manipulator is enabled and the second position is located between the first position and the third position.

15. The robot according to claim 1, wherein the handle is capable of allowing a robot control apparatus to store at least one of a position and an attitude of the manipulator.

16. The robot according to claim 1, wherein, as the manipulators, a first manipulator and a second manipulator different from the first manipulator are provided.

17. A robot system comprising:
the robot according to claim 1; and
a robot control apparatus that controls the robot.

18. A robot system comprising:
the robot according to claim 2; and
a robot control apparatus that controls the robot.

19. A robot system comprising:
the robot according to claim 3; and
a robot control apparatus that controls the robot.

20. A robot system comprising:
the robot according to claim 4; and
a robot control apparatus that controls the robot.
